(19) United States
(12) Patent Application Publication
(10) Pub. No.: US 2009/0129682 A1
(43) Pub. Date: May 21, 2009

(54) METHOD AND SYSTEM FOR THE OPTICAL INSPECTION OF A PERIODIC STRUCTURE

(76) Inventors: Enis Ersue, Darmstadt (DE); Wolfram Laux, Seeheim-Jugenheim (DE)

Correspondence Address: MICHAEL J. STRIKER, 103 EAST NECK ROAD, HUNTINGTON, NY, 11743, US

(21) Appl. No.: 12/160,016

(22) PCT Filed: Dec. 19, 2006
(86) PCT No.: PCT/EP2006/012233

§ 371 Date: Oct. 8, 2008

(30) Foreign Application Priority Data
Jan. 7, 2006 (DE) 10 2006 000 946.0

(51) Int. Cl. G06K 9/62

(52) U.S. Cl. 382/209

(57) ABSTRACT

Disclosed are a method and a system for inspecting a periodic structure (1) by means of an optical image recorder which is provided with a pixel structure (2) and whose recorded image (6) is compared to a faultless reference image (4) of the periodic structure (1). In order to be able to reliably detect faults with simple means, the phase angle (phase X, phase Y) of the periodic structure (1) relative to the pixel structure (2) of the optical image recorder is determined in at least one position (X, Y) of the reference image (4). The recorded image (6) is subdivided into inspection areas (7), and the phase angle (phase X, phase Y) of the periodic structure (1) relative to the pixel structure (2) of the image recorder is determined for each inspection area (7). In order to compare an inspection area (7) to the reference image (4), a reference image area (8) is then selected whose phase angle (phase X, phase Y) corresponds to the inspection area (7).

The invention relates to a method and a system for the inspection of a periodic structure by means of an optical image recorder having a pixel structure, and whose recorded image in particular is compared to a faultless reference image of the periodic structure by means of an image evaluation known per se, in order to determine, for example, faults in the periodic structure of the recorded image.

The invention can be used for inspection of very fine periodic structures of a period which is very small in comparison to the total area of the surface to be inspected. An example for this is the inspection of colour filters for LCD screens in which, in a periodic order next to each other, red, yellow and green filter elements are arranged, by selective backlighting of which a coloured image can be produced for the viewer.

Such structures very often are still to be inspected for defects during the production process. A known method in this regard consists in recording the structures to be inspected and comparing by means of an appropriate image processing with faultless reference images of these structures.

The optical image recorders used for image recording, for example CCD cameras, due to their configuration, have a periodic pixel structure themselves, on which the image to be recorded is imaged with the periodic structure, and is divided into pixels and digitalised. As long as a periodic structure to be recorded is large enough in comparison to the pixel resolution of the optical image recorder, transitions of the periodic structures can easily be identified in the recorded image, since an area that appears in the recording as identical is imaged within the period of the structure to be recorded on a large number of pixels of the image recorder, and a transition in the periodic structure takes place in small number of pixels in comparison thereto. Hence the periodic structure is recorded with a high resolution.

If however a large area is to be recorded which has a small periodic structure in relation to the dimensions of the area, a high resolution of the optical image recorder, required for an optimal image evaluation, can only be achieved with a considerable expenditure of technical equipment, the cost of which is in most cases not in proportion to the desired inspection task.

Thus, in practice, for the inspection of patterns with a large area and small periodic structures, normally optical recording devices with a small resolution are used, so that with one recording device, large portions of the pattern to be inspected can be recorded at once. This causes, however, that one structure element of the periodic structure to be inspected is imaged on a similar number of pixels of the recording device, for example one structure element on three to four pixels. By means of the superimposition of the structure to be inspected with the also periodic pixel structure, therefore artefacts are generated in the recorded picture by sub-pixel shifts, if the period ratio of the periodic structure to be inspected and the pixel structure are not exactly an integer and the phase angle is not exactly constant. Since such conditions in practice can hardly be achieved or only with enormous expenditure, the value in a pixel of the recorded image thus depends highly on the phase angle at recording, so that an immediate comparison with a reference image does not allow a sufficiently accurate conclusion about the presence of a fault in the periodic structure to be inspected.

From DE 101 61 737 C1 a method for detecting a fault in a periodic surface structure is known, in which the measured original value of at least one current segment of a period is compared with at least two further measured original values of respective segments of other periods of the structure to be inspected. Hereby the median of the analysed original values is determinded and used in an image reproduction as the value of the segment of the periodic structure which corresponds to the current segment. Thereby, by means of comparison segments of an image reproduction of the periodic structure is generated, which substantially corresponds to an ideal periodic structure, because a potential fault, by replacing the segment including the same with such segments, which correspond to a faultless structure, is masked out. From the ideal image generated that way and the original values of the recorded image, a differential image is created in order to identify faults in the structure.

By forming the median, problems due to the determination of the phase angle are partially filtered out. Solely because of the phase relation between the periodic structure and the pixel structure at recording, assumed faults however are identified in practice, which don't exist in the real structure.

In U.S. Pat. No. 5,513,275 A is described that for the comparison of the recorded image with the reference image, not a reference image is used which is recorded by means of an optical recording device, but, after detection of a pattern, its periodic structure is determined mathematically. However, this requires a very high computing expenditure.

It is the object of the present invention to provide a simple and inexpensive option for the inspection of a small periodic structure on a large area, by means of which faults in a periodic structure can reliably be detected.

This object is achieved by means of a method and a system according to the claims 1 and 11. In the method according to the invention is provided that in the reference image in at least one or preferably more positions, the phase angle of the periodic structure imaged in the reference image is determined relative to the pixel structure of the optical image recorder, and is preferably saved together with the reference image. The recorded image of the surface to be inspected is then divided into inspection areas. For each inspection area, the phase angle of the periodic structure imaged in the inspection area is determined relative to the pixel structure of the image recorder, by which in particular also the reference image can be recorded in a comparable arrangement. For a comparison of an inspection area with the reference image, a respective reference image is then selected whose phase angle corresponds to the phase angle of the inspection area. The size of the reference image area is preferably adjusted to the size of the inspection area.

With the determination of the phase angle of the periodic structure imaged in the inspection area relative to the pixel structure of the optical image recorder, which can be performed with methods known by those skilled in the art, it is possible to select a reference image area within the reference image, which has the same or at least a very similar phase angle. Thereby the influences of the different phase angles between the pixel structure and the periodic structure to be inspected are eliminated upon comparison of the recorded image with the reference image in a simple manner and without high expenditure, so that faults can be detected with high reliability.

For implementation of the method according to invention it is preferably provided that for the selection of the reference image area, a position of the reference image is selected, whose phase angle has the smallest phase difference to the phase angle of the inspection area. Hereby, depending on the condition of the structure to be inspected, the different phase directions, for example in X-direction and Y-direction, can be weighted differently, in particular if there are sharp contours in a phase direction which have a major effect on the evaluation of the pixels. In principle, however, the different phase directions can also be weighted the same.

If an inspection area and a reference image area are selected always in the same size, at each position at which the phase angle of the periodic structure is determined in the reference image, a corresponding reference image area, as image and/or position in an image, and the corresponding phase angle can be saved. If this information is accessible in a memory, the time required for the comparison can be decreased and hence the inspection speed can be increased.

For storage of the reference image area and the phase angle, it is in particular advantageous to save a table, in which the phase angles in different phase directions and the position of a defined point of the reference image area, for example a defined corner, are saved. The table can be search-optimised in a way that the search for the table entries with the smallest phase differences in the different phase directions, in particular the X- and the Y-direction, can be accomplished within a minimal search time. Such a discrete table allows an extra fast assignment of suitable reference image areas to an inspection area.

It is in particular advantageous if in the reference image, the phase angle of the periodic structure relative to the pixel structure is determined at each repeating period of the periodic structure. Thereby the whole reference image is covered so that the determination of almost all virtually occurring phase angles is possible and a very good correlation of the phase angles between the reference image area and the inspection area can be achieved. Basically, it would also be possible, after a one-time determination of the phase angle in a reference image, to calculate the phase angle at each period of the periodic structure. Since in practice however, there are, in addition, also non-periodic phase variations, which, for example, can result from inaccuracies of the transport system during image acquisition, it is advantageous to determine the phase angles at each period separately.

In order, for example, to minimise image faults of the optical image recorder, a reference image area for comparison with the inspection area can be used, which in particular with regard to the image section of the whole image recorded by the image recorder is located in spatial proximity to the inspection area. This selection has preferably then an effect, if, for an inspection area, multiple reference image areas with a comparably good phase angle are available. The principally advantageous demand of a preferably proximate spatial neighbourhood of reference image area and inspection area within the whole image is given, according to the invention, a lower weighting for the benefit of the phase accuracy. A joint evaluation of the phase correlation with a secondary weighting of the spatial neighbourhood of the areas to be compared can take place by definition of a quality function.

It is principally advantageous, if the inspection area does not cover the whole recorded image but selects a section of the recorded image, because in smaller image sections optical image faults of the image recorder or non-periodic phase variations, for example due to inaccuracies of the transport system, do not have a high effect, so that for these inspection areas constant conditions can be assumed.

If the inspection area is selected considerably smaller than the section of the recorded image, according to the invention, the reference image area and the inspection area can come from the same recorded image.

To ensure freedom from faults of the reference image areas, it can be provided according to the invention, that a reference image area is inspected for freedom from faults by comparison with other reference image areas according to the specified method. This is in particular advantageous because with the above-described method, a recorded reference image also must not be free from local faults. The inspection can, for example, be carried out such, that after creation of a reference phase table with the saved reference image areas, a self-inspection of each reference image is performed analogue to a normal inspection. In case of a local defect, the exact position of the local defect can then be determined in a further comparison, and hence the section of the reference image including the local defect can be erased from the reference phase table. That way a freedom from faults of the used reference image areas can be achieved.

In order to achieve a dynamic management of the reference image areas, according to the invention, inspection areas which are detected as faultless, can subsequently also be used as reference image areas, and can in particular be saved with the phase angle in, for example, the reference phase table. In order to use for the comparison preferably current reference image areas, the management can be organised in form of a First-In-First-Out-Memory (FIFO), so that respectively older reference image areas are successively erased while filling up during the running inspection process. A dynamic reference image management allows also the start of the inspection system according to the invention with only few saved reference image areas and a self-learning system.

Alternatively or additionally to the recording of a reference image, a reference image can also be calculated from multiple, in particular recorded reference image areas. This can be carried out such that from multiple recorded reference images and reference image areas, respectively, in a varying phase angle, a mathematical model for the relation between phase angle and corresponding image is calculated. Then for each actually occurring phase angle, the reference image can be calculated during the inspection in order to obtain a comparable phase angle between the reference image area and the inspection area. In this case, in the reference image, the phase angle of the optical structure relative to the pixel structure of the optical image recorder at a position can hence be determined by calculation and used for the comparison with the inspection area.

The real image comparison of an inspection area with a reference image area preferably takes place, according to the invention, by subtraction or division of the equally sized areas which correlate in their phase angle. Then the result is an image with the same intensity, which shows deviations only in case of existence of local defects, which can easily be detected and processed with known methods of image processing.

According to the invention, the invention relates also to a system for inspection of a periodic structure with an optical image recorder with a pixel structure for recording of images of the periodic structure, and an image processing with memory. The image processing is set up, according to the invention, in a manner that in particular in a recorded reference image, at at least one or more positions, the phase angle of the optical structure relative to the pixel structure of the optical recorder is determined, that the recorded image is divided into inspection areas, and for each inspection area, the phase angle of the periodic structure relative to the pixel structure of the optical image recorder is determined, and that for the comparison of an inspection area with the reference image a reference image area is selected, whose phase angle corresponds to the phase angle of the inspection area. According to the invention, of course the further method steps and options of the foregoing described method can be implemented in the image processing.

In addition, the image processing can comprise a Field-Programmable-Gate-Array (FPGA), in which the individual method steps are calculated. The reference images and/or the reference image areas can then, for example, be filed in a memory directly connected with a Field-Programmable-Gate-Array. An increase of the processing speed can be achieved in that the reference images and/or the reference image areas with the associated phase angle are saved in the Field-Programmable-Gate-Array itself, because thereby the access times as a whole are shortened. Hereby it is in particular space-saving if the image data of the reference image are saved exactly only one time, and the reference image areas are saved by indication of the position (X, Y), which is correlated with the pixels in the reference image. From the position (X, Y) and the desired size of the area the reference image area can then easily be selected in the saved reference image.

The particular advantage of the present invention, therefore, is that with the comparison between the recorded inspection area and the reference image area, the phase angle between the periodic structure to be inspected and the pixel structure of the image recorder is considered so that different phase angles in the reference image area and the inspection area do not result in artefacts anymore, which wrongly indicate assumed defects in the periodic structure.

Further features, advantages and application possibilities of the invention arise from the following description of a preferred embodiment and the drawing. Hereby all described and/or illustrated features on its own, or in any combination, constitute the subject matter of the present invention, independent from their combination in the claims or the relations thereof.

In the figures

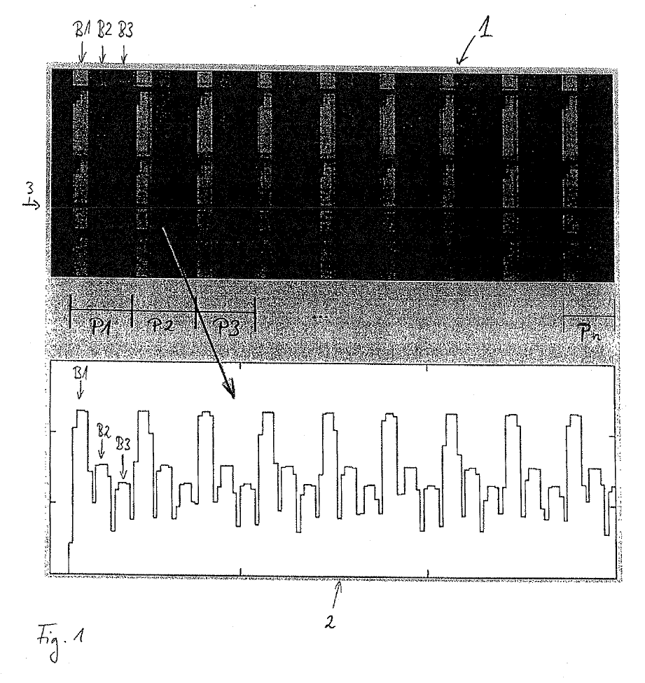

FIG. 1 shows an image of a periodic structure to be inspected and a corresponding image line of an optical image recorder;

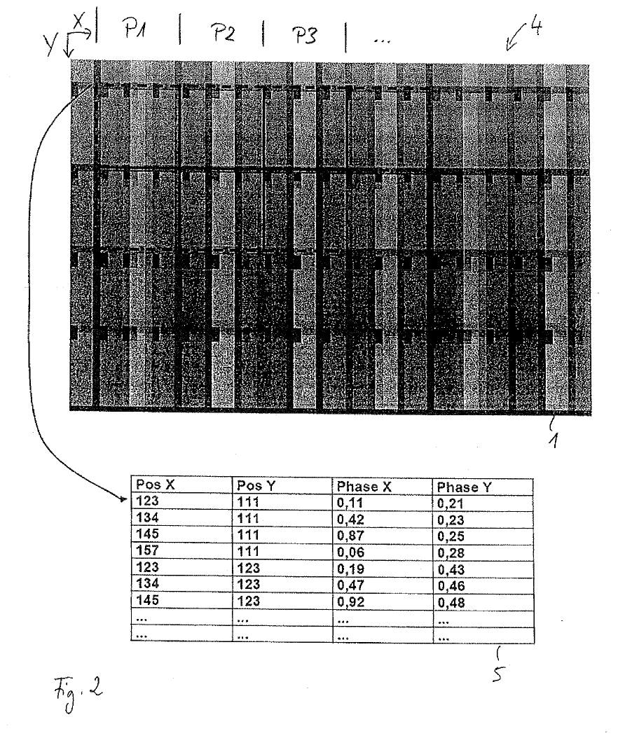

FIG. 2 shows a reference image according to the present invention, in which the phase angle between the periodic structure to be inspected and the pixel structure of the image recorder is determined;

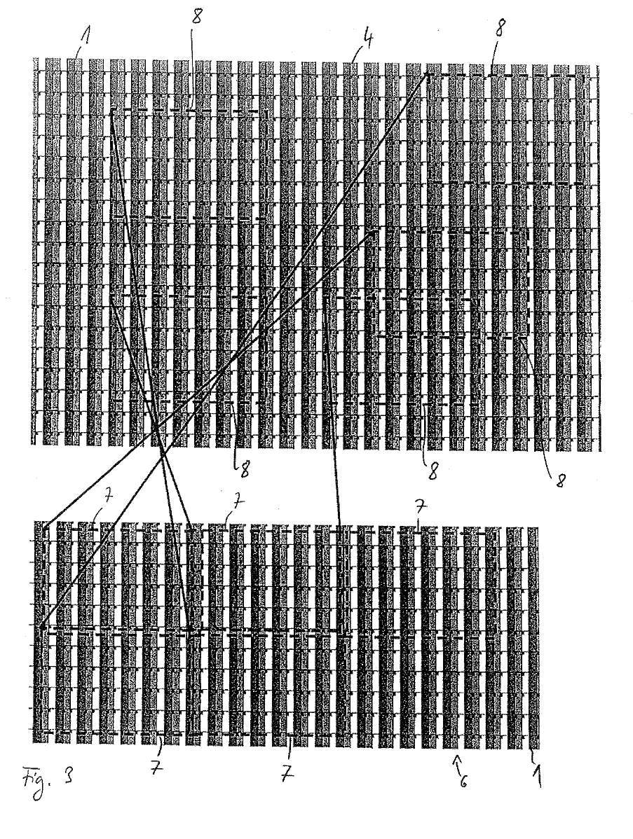

FIGS. 3a and 3b show the assignment of reference image areas to inspection areas in a recorded image, wherein the lines with identical letters a, b, c, d, e are connected in the FIGS. 3a and 3b, and

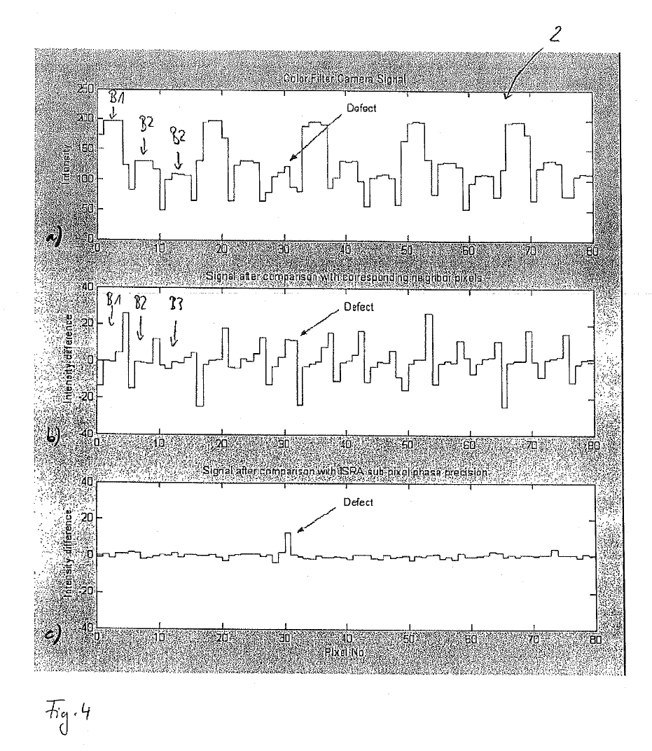

FIG. 4 shows a recorded image line of a periodic structure with the comparison of a known evaluation method to the evaluation method according to the invention.

In FIG. 1 a periodic structure 1 is illustrated, which is to be inspected by means of an optical image recorder. In the horizontal direction, the periodic structure comprises the periods P1 to Pn, which are small in comparison to the total area of the pattern to be inspected with the periodic structure 1. The optical image recorder, by means of which the periodical structure 1 is recorded, comprises on its part a pixel structure 2, which corresponds to its resolution. A pixel is defined by the width of an entry in the pixel structure 2. The illustrated pixel structure 2 corresponds to a horizontal image line 3 in the periodic structure 1.

The periodic structure 1 consists of three adjacent areas, B1, B2 and B3, with different brightness, which are repeating with the period Pi, I=1 to n. These areas B1, B2 and B3 exhibit in the pixel structure shown as intensity illustration through peaks of different heights, which are repeating substantially periodically. A known traditional method for inspection of such structures 1 is the comparison with a saved nominal pattern. However, this is very difficult to realise in a case where fine structures of, for example, few μm in size are applied on relatively large areas of 1 to 2 m², because then a very high amount of data needed to be saved. Therefore methods for periodic structures were developed in which the adjacent structure elements are used as pattern for the structure element to be inspected, so that it is not necessary to save the whole pattern as reference image.

The traditional algorithm for this inspection is a comparison of each individual pixel with the mean value of the two pixels corresponding to the period distance P of the preceding and succeeding period, respectively. Hereby, for example, a fault is assumed if the pixel to be inspected deviates too much from this mean value.

Looking closer at pixel structure 2 in FIG. 1 it can be noticed that in the individual periods P1 to Pn there are differences in the structure of the peaks corresponding to the areas B1, B2 and B3. Those result from the phase angle of the periodic structure P1 to be inspected and the pixel structure 2 being different in each period P1 to Pn. The pixel structure 2 is determined by the resolution of the optical image recorder, which can be read in the pixel structure 2 by means of the length of the smallest horizontal entry in the intensity distribution.

The intensity of a pixel upon transition from an area B1 into an area B2 depends on to what extent the one pixel of the pixel structure 2 can still be assigned to the respective area, or is located already in an intermediate area, respectively. If a phase-correct recorded image would be present as reference image or a transformation into the correct phase angle would be performed, the inspection could be achieved by a simple comparison between the reference image and the recorded image. This is implemented in the method proposed by the invention and in a corresponding system, respectively, and illustrated below by means of FIGS. 2 and 3.

In FIG. 2 a reference image 4 with the periodic structure 1 is illustrated, for which at multiple positions X, Y the phase angles phase X, phase Y of the periodic structure 1 are determined relative to the pixel structure 2 of the optical image recorder. The determination of the phase angle of an image relative to a structure taken by the image can be performed by those skilled in the art with current methods, known per se, so that they don't have to be explained in detail. Hereby the positions X, Y are selected in a manner that the phase angle of the periodic structure 1 is determined in X-direction at each period P1, P2, P3, etc . . . The same is valid for the phase angle in Y-direction.

The determined values are entered into a reference phase table 5, which Comprises the position X, Y in the reference image 4 together with the associated phases phase X, phase Y in X- and Y-direction so that the reference image 4 at each period Pi is inspected for the actually occurring sub-pixel phase shifts in X- and Y-direction. All determined phase shifts are saved in a reference phase table so that with the reference image 4 additionally stored in the memory of the image processing, at the positions X and Y listed in the table, reference image areas of any size can be extracted from the reference image 4 with known phase angle.

This is used, as illustrated in FIG. 3, for the real inspection of the periodic structure 1. In FIG. 3 a recorded image 6 with the periodic structure 1 to be inspected is illustrated. In the recorded image 6 inspection areas 7 are defined with slight overlapping, which are each inspected individually, one after the other. The size of the inspection areas 7 is hereby adjusted in a manner that, for the size of the inspection areas 7, constant optical conditions can be expected.

Upon performance of the inspection, first for each inspection area 7 the phase angle (phase X, phase Y) of the periodic structure 1 imaged in the inspection area 7 is determined relative to the pixel structure 2 of the optical image recorder. Depending on this phase angle, for the comparison of the inspection area 7 with the reference image 4, a reference image area 8 is selected in the reference phase table 5, which has the same size as the inspection area 7 and whose phase angle corresponds to the phase angle of the inspection area 7. For this, a phase pair phase X, phase Y is selected from the reference phase table 5, which has the smallest phase difference to the phase angle phase X, phase Y of the inspection area 7. The assignment of individual reference image areas 8 to the respective inspection areas 7 is illustrated in FIG. 3.

For the inspection of the periodic structure, the inspection areas 7 and reference image areas 8 are subtracted from each other. Due to the almost identical phase angle of the two areas 7, 8, a comparison image arises with almost constant intensity, in which individual faults can easily be identified.

The advantages of the above described method compared to a method in which the pixel values are simply compared with the mean value of the corresponding pixels of the preceding phase P(i−1) and the succeeding phase P(i+1), are illustrated in FIG. 4.

It shows in FIG. 4a a section from pixel structure 2, illustrated in FIG. 1, along the image line 3. In the area of pixel no. 30 a fault (defect) is marked.

FIG. 4b shows a differential image in which FIG. 4a is subtracted from an image reproduction, in which respectively the mean values of the pixels of the preceding and succeeding periods are entered. Since at the transitions of the respective areas B1, B2, B3 of the periodic structure 1, because of the different phase angles, intensity variations occur between the recorded image 6 and the reference image 4, the fault at pixel no. 30 can hardly be identified.

In comparison to that, the defect at pixel no. 30 is clearly seen in the intensity distribution illustrated in FIG. 4c.

This intensity distribution was generated by the foregoing described inspection of periodic structures with a phase-exact comparison by means of a subtraction of the recorded image 6 and the reference image 4. Therefore, with the present invention, a periodic structure can reliably be inspected for faults.

### REFERENCE LIST

1 Periodic structure

2 Pixel structure

3 Image line

4 Reference image

5 Reference phase table

6 Recorded image

7 Inspection area

8 Reference image area

P1 to Pn Period

B1, B2, B3 Areas

X, Y Position

1. A method for inspection of a periodic structure (1) by means of an optical image recorder with a pixel structure (2), whose recorded image (6) is compared to a faultless reference image (4) of the periodic structure (1), characterized in that in the reference image (4), at at least one position (X, Y), the phase angle (phase X, phase Y) of the periodic structure (1) relative to the pixel structure (2) of the optical image recorder is determined, that the recorded image (6) is divided into inspection areas (7), and for each inspection area (7), the phase angle (phase X, phase Y) of the periodic structure (1) relative to the pixel structure (2) of the optical image recorder is determined, and that for the comparison of an inspection area (7) with the reference image (4), a reference image area (8) is selected, whose phase angle (phase X, phase Y) corresponds to the inspection area (7).

2. The method according to claim 1, characterized in that for selection of the reference image area (8), a position (X, Y) of the reference image (4) is selected, whose phase angle (phase X, phase Y) has the smallest phase difference to the phase angle (phase X, phase Y) of the inspection area (7).

3. The method according to claim 1, characterized in that at each position (X, Y), at which the phase angle (phase X, phase Y) is determined in the reference image (4), a reference image area (8) and the phase angle (phase X, phase Y) are saved.

4. The method according to claim 1, characterized in that the phase angle (phase X, phase Y) of the periodic structure (1) relative to the pixel structure (2) is determined at each period (P) of the periodic structure (1).

5. The method according to claim 1, characterized in that for the comparison to the inspection area (7), a reference image area (8) is used, which is located in spatial proximity to the inspection area (7).

6. The method according to claim 1, characterized in that the reference image area (8) is a segment of the recorded image (6), and is different from the inspection area (8).

7. The method according to claim 1, characterized in that a reference image area (8) is inspected for freedom of faults by means of comparison with other reference image areas (8).

8. The method according to claim 1, characterized in that inspection areas (7), detected as faultless, are used as reference image areas (8).

9. The method according to claim 1, characterized in that a reference image (4) is calculated from multiple reference areas (8).

10. The method according to claim 1, characterized in that the comparison of an inspection area (7) with a reference area (8) takes place by means of a subtraction or division of the equally sized areas (7, 8).

11. A system for inspection of a periodic structure (1), with an optical image recorder having a pixel structure (2) for recording of images of the periodic structure (1) and an image processing with memory, characterized in that the image processing is set up in a manner that within a reference image (4), at at least one position (X, Y), the phase angle (phase X, phase Y) of the periodic structure (1) relative to the pixel structure (2) of the optical image recorder is determined, that a recorded image (6) is divided in inspection areas (7), and for each inspection area (7), the phase angle (phase X, phase Y) of the periodic structure (1) relative to the pixel structure (2) of the optical image recorder is determined, and that for the comparison of an inspection area (7) with the reference image (4) a reference image area (8) is selected, whose phase angle (phase X, phase Y) corresponds to the inspection area (7).

12. The system according to claim 11, characterized in that the image processing comprises a Field-Programmable-Gate-Array, in which the individual method steps are calculated.

13. The system according to claim 12, characterized in that the reference images (4) and/or the reference image areas (8), with the associated phase angle (phase X, phase Y), are saved in the Field-Programmable-Gate-Array.
